(19) United States
(12) Patent Application Publication
(10) Pub. No.: US 2024/0286857 A1
(43) Pub. Date: Aug. 29, 2024

(54) SHEET FEEDING APPARATUS AND IMAGE FORMING APPARATUS

(71) Applicant: CANON KABUSHIKI KAISHA, Tokyo (JP)

(72) Inventors: AKIHIRO KAWAKITA, Chiba (JP); SEITA INOUE, Chiba (JP); TERUHITO KAI, Chiba (JP); TATSUO FUJIMURA, Chiba (JP); HIROAKI TOMIYASU, Ibaraki (JP)

(21) Appl. No.: 18/585,399

(22) Filed: Feb. 23, 2024

(30) Foreign Application Priority Data
Feb. 28, 2023 (JP) 2023-029977

(51) Int. Cl. B65H 7/16; B65H 3/08; B65H 7/02; G03G 15/00

(52) U.S. Cl. CPC B65H 7/16; B65H 3/08; B65H 7/02; G03G 15/6511; G03G 15/6514; B65H 2406/10

(57) ABSTRACT

A sheet feeding apparatus includes a supporting portion, a feeding portion, a separating portion, a type detection portion, a control portion, and a type input portion. The type input portion inputs information on a type of the sheet supported by the supporting portion. The control portion selectively executes a first mode in which the type of the sheet supported by the supporting portion is set by information detected by the type detection portion while the sheet is fed, and a second mode in which the type of the sheet supported by the supporting portion is set by the information input by the type input portion to execute feeding of the sheet. The control portion executes a setting process of setting an air blowing operation to be executed in the first mode, and a choosing process of choosing one of the first mode and the second mode.

### BACKGROUND OF THE INVENTION

### Field of the Invention

The present invention relates to a sheet feeding apparatus including a separating portion that blows air to a plurality of sheets supported by a support to separate the sheets, and an image forming apparatus.

### Description of the Related Art

For example, an image forming apparatus such as a copying machine, a facsimile, or a printer is provided with a manual feed tray, a sheet feeding cassette, or the like as a sheet feeding apparatus that feeds sheets to an image forming portion that forms images on the sheets, or a feeding deck or the like is externally attached thereto. In recent years, there is an increasing demand for image formation on various types of sheets, and sheets having a smooth surface such as coated paper may be used. When such a sheet bundle of sheets having a smooth surface is set in the sheet feeding apparatus as described above, the strong adhesion between sheets may prevent them from separating and feeding failure may occur. A technique has been proposed that performs the so-called air separation in which air is blown to the set sheet bundle to cause the sheets to float and separate (see JP 1992-23747 A).

On the other hand, since various types of sheets are used, an image forming apparatus including a medium detection sensor that detects the type of the sheet has also been proposed (see JP 2022-62122 A). Image forming apparatuses like this apparatus having a medium detection sensor that detects (determines) the type of the sheet set the operation conditions of the image forming process according to the characteristics of the detected sheet type, including setting the sheet conveyance speed, adjusting the output of the development/transfer, and adjusting the fixing temperature. These apparatuses aim to perform optimum image formation according to the type of sheet.

Meanwhile, for example, when a sheet bundle is set in the sheet feeding apparatus for sheet replacement or the like, or when the power is turned on again and the image forming apparatus wakes up from a power saving mode or the like, the type of the sheets set in the sheet feeding apparatus is unknown. In such cases, apparatuses that detect the sheet type o using a medium detection sensor as in JP 2022-62122 A cannot detect the sheet type until the first sheet is fed and detected by the medium detection sensor.

Apparatuses that perform air separation as in JP 1992-23747 A do not need to perform air separation for sheets having a low adhesion between them such as regular paper, but are required to perform air separation for sheets having a smooth surface such as coated paper. Because of this, although it is desired to determine whether air separation can be performed according to the sheet type, apparatuses that detect the sheet type by the medium detection sensor as in JP 2022-62122 A cannot determine the sheet type of the first sheet. Since the sheet may not be able to be fed without air separation when the sheet has a smooth surface like coated paper, the apparatus may be configured to perform air separation when the sheet type is unknown. However, if air separation is indiscriminately performed in this manner, air separation would also be performed on sheets that do not adhere to each other so strong that air separation is not required. This may delay the feeding of the first sheet and lower the so-called first copy output time (FCOT).

An object of the present invention is to provide a sheet feeding apparatus that can prevent the feeding of the first sheet from being delayed in a first mode in which the sheet type is detected by a type detection portion, and an image forming apparatus.

### SUMMARY OF THE INVENTION

According to a first aspect of the present invention, a sheet feeding apparatus includes a supporting portion configured to support a plurality of sheets, a feeding portion configured to feed a sheet supported by the supporting portion, a separating portion configured to blow air to the plurality of sheets supported by the supporting portion to separate the sheets, a type detection portion configured to detect a type of the sheet fed by the feeding portion, a control portion configured to control an air blowing operation by the separating portion according to the type of the sheet, and a type input portion configured to be input information on the type of the sheet supported by the supporting portion. The control portion is configured to selectively execute a first mode in which the type of the sheet supported by the supporting portion is set by information detected by the type detection portion while the sheet is fed, and a second mode in which the type of the sheet supported by the supporting portion is set by the information input by the type input portion to execute feeding of the sheet. The control portion is configured to execute a setting process of setting the air blowing operation to be executed in the first mode, and a choosing process of choosing one of the first mode and the second mode.

According to a second aspect of the present invention, an image forming apparatus includes the sheet feeding apparatus, and an image forming portion configured to form an image on a sheet fed by the sheet feeding apparatus.

Further features of the present invention will become apparent from the following description of exemplary embodiments with reference to the attached drawings.

### BRIEF DESCRIPTION OF THE DRAWINGS

FIG. 1 is a diagram illustrating a schematic configuration of an image forming system according to a first embodiment.

FIG. 2 is a block diagram of the control system of the image forming system according to the first embodiment.

FIG. 3 is a schematic diagram illustrating a configuration of the manual feed portion according to the first embodiment.

FIG. 4 is a schematic diagram illustrating a state in which the air blowing operation is performed in the manual feed portion according to the first embodiment.

FIG. 5 is a cross-sectional view illustrating the configuration of the medium detection sensor according to the first embodiment.

FIG. 6 is a flowchart illustrating a process carried out when the power is turned on according to the first embodiment.

FIG. 7 is a flowchart illustrating a process of separating setting according to the first embodiment.

FIG. 8 is a view illustrating a setting screen of the air blowing operation according to the first embodiment.

FIG. 9 is a flowchart illustrating a process performed in the case where a sheet is set in the sheet feeding tray according to the first embodiment.

FIG. 10 is a flowchart illustrating a medium information setting process according to the first embodiment.

FIG. 11 is a view illustrating a screen for setting a medium information determination method according to the first embodiment.

FIG. 12 is a view illustrating a screen for setting the sheet thickness according to the first embodiment.

FIG. 13 is a view illustrating a screen for setting the sheet surface property according to the first embodiment.

FIG. 14 is a flowchart illustrating part of a process performed in the case where a job is input according to the first embodiment.

FIG. 15 is a flowchart illustrating the following steps of the process performed in the case where a job is input according to the first embodiment.

FIG. 16 is a flowchart illustrating the separating process according to the first embodiment.

FIG. 17 is a flowchart illustrating a medium information setting process according to the second embodiment.

### DESCRIPTION OF THE EMBODIMENTS

### First Embodiment

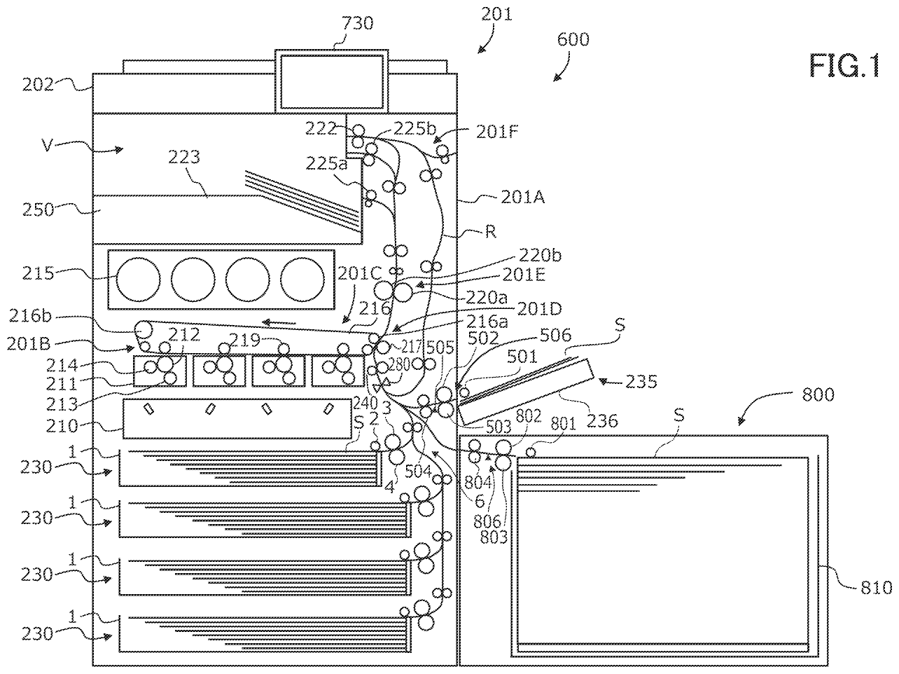

A first embodiment according to the present invention will be described in detail with reference to the drawings. First, an image forming system 600 including an image forming apparatus 201 and a manual feed portion 235 as a sheet feeding apparatus connected to the image forming apparatus will be described with reference to FIG. 1. FIG. 1 is a diagram illustrating a schematic configuration of the image forming system according to the first embodiment.

### Schematic Configuration of Image Forming System

As illustrated in FIG. 1, the image forming system 600 includes the image forming apparatus 201, the manual feed portion 235, and a feeding deck 800 connected to the image forming apparatus 201. The feeding deck 800 is connected to the right side of the image forming apparatus 201 in FIG. 1, and is configured to feed a sheet S to the image forming apparatus 201. The manual feed portion 235 is also configured to feed the sheet S to the image forming apparatus 201. Schematic Configuration of Image Forming Apparatus

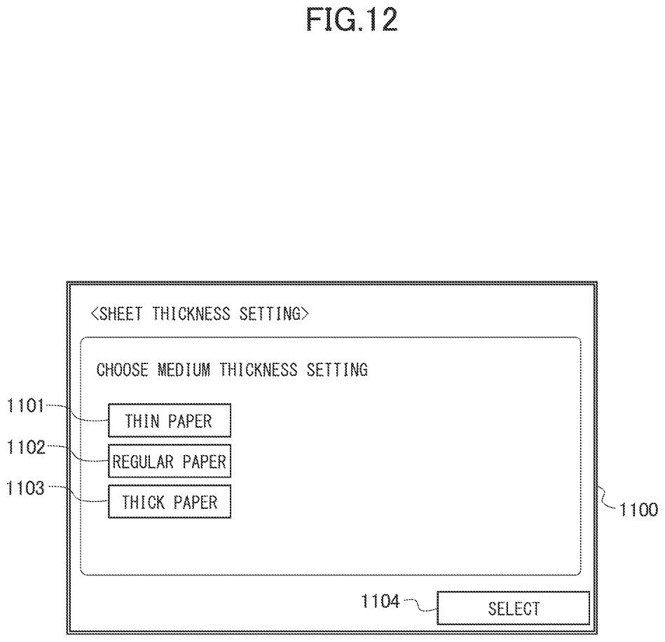

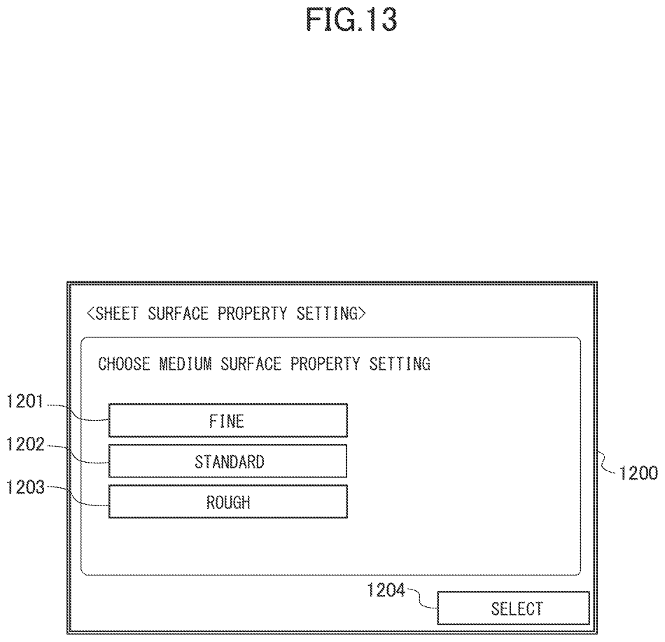

As illustrated in FIG. 1, the image forming apparatus 201 includes an apparatus body 201A including an image forming portion 201B that forms an image on a sheet. An image reading apparatus 202 installed substantially horizontally is disposed above the apparatus body 201A. A discharge space V for sheet discharge is formed between the image reading apparatus 202 and the apparatus body 201A. An operation portion 730, which is a UI including a touch panel or the like capable of displaying a screen, is disposed above the apparatus body 201A. Note that the operation portion 730 according to the present embodiment forms a type input portion that inputs the sheet type (see FIGS. 12 and 13) when it is in a user setting mode described in detail later.

The image forming portion 201B is a four-drum full color system. The image forming portion 201B includes a laser scanner 210 and four process cartridges 211Y, 211M, 211C, and 211K that form toner images of four colors of yellow (Y), magenta (M), cyan (C), and black (K). Each process cartridge 211 includes a photosensitive drum 212, a charger 213 as a charging member, and a developer 214 as a developing member. The image forming portion 201B includes an intermediate transfer portion 201C disposed above the process cartridge 211 and a fixing portion 201E. A toner cartridge 215 for supplying toner to the developer 214 is provided above the intermediate transfer unit 201C.

The intermediate transfer unit 201C includes an intermediate transfer belt 216 wound around a driving roller 216a and a tension roller 216b. A primary transfer roller 219 is provided inside the intermediate transfer belt 216. The primary transfer roller 219 is located so as to face the photosensitive drum 212 and abut on the intermediate transfer belt 216. Here, the intermediate transfer belt 216 is rotated in the direction of the arrow by the driving roller 216a driven by a driving portion (not illustrated).

The toner images of the respective colors having a negative polarity on the photoconductor drums are sequentially transferred in an overlapping manner onto the intermediate transfer belt 216 by the primary transfer rollers 219. A secondary transfer roller 217 that transfers a color image formed on the intermediate transfer belt to the sheet S is located so as to face the driving roller 216a of the intermediate transfer unit 201C. A secondary transfer portion 201D is formed by the intermediate transfer belt 216 and the secondary transfer roller 217. Furthermore, a fixing portion 201E including a pressure roller 220a and a heating roller 220b is disposed above the secondary transfer roller 217. A first sheet discharge roller pair 225a, a second sheet discharge roller pair 225b, and a duplex reversing portion 201F are disposed above the fixing portion 201E. The duplex reversing portion 201F includes a reverse conveyance roller pair 222 capable of rotating forward and backward, and a re-conveyance path R for conveying a sheet having an image formed on one side thereof to the image forming portion 201B again.

A plurality of sheet feeding units 230 for feeding the set sheets S to the image forming portion 201B is provided a lower part of the apparatus body 201A. Each of the plurality of sheet feeding units 230 includes a feeding cassette 1 that stores a plurality of sheets (sheet bundle) and a sheet feeding portion 6 as a feeding portion that feeds the sheets S stored in the feeding cassette 1. The sheet feeding potion 6 includes a pickup roller 2, and a feed roller 3 and retard roller 4 as a separating member that separates sheets S fed in a bundle (that is, fed in a double feeding manner) from the pickup roller 2.

Further, a feeding deck 800 that feeds the set sheet S to the image forming portion 201B is provided below the manual feed portion 235, on the right face of the apparatus body 201A in FIG. 1. The feeding deck 800 includes a sheet feeding portion 806 similarly to the sheet feeding unit 230. That is, the sheet feeding portion 806 includes a pickup roller 801, and a feed roller 802 and retard roller 803 as a separating member that separates sheets S fed in a bundle from the pickup roller 801. A drawing roller pair 804 is provided downstream of the sheet feeding portion 806 in the sheet conveyance direction.

In addition, a manual feed portion 235 that feeds a sheet S from the plurality of sheets S (sheet bundle) set by manual feed to the image forming portion 201B is provided on the right face of the apparatus body 201A in FIG. 1. The manual feed portion 235 can pivot with respect to the apparatus body 201A so that it can be opened and closed. In other words, it is arranged so that it can switch between an open state in which it is open with respect to the apparatus body 201A and a closed state in which it is closed with respect to the apparatus body 201A. The manual feed portion 235 includes a sheet feeding tray 236 serving as a manual feed tray that supports the sheets S when it is in the open state, and includes a sheet feeding portion 506 similarly to the sheet feeding unit 230. That is, the sheet feeding portion 506 includes a pickup roller 501, and a feed roller 502 and retard roller 503 as a separating member that separates sheets S fed in a bundle from the pickup roller 501. A drawing roller pair 504 is provided downstream of the sheet feeding portion 506 in the sheet conveyance direction.

Note that a medium detection sensor 280 as a type detection portion is disposed by the conveyance path of the apparatus body 201A to detect the grammage and surface property of the sheet S that has been conveyed. The medium detection sensor 280 will be described later.

### Operation of Image Forming Apparatus

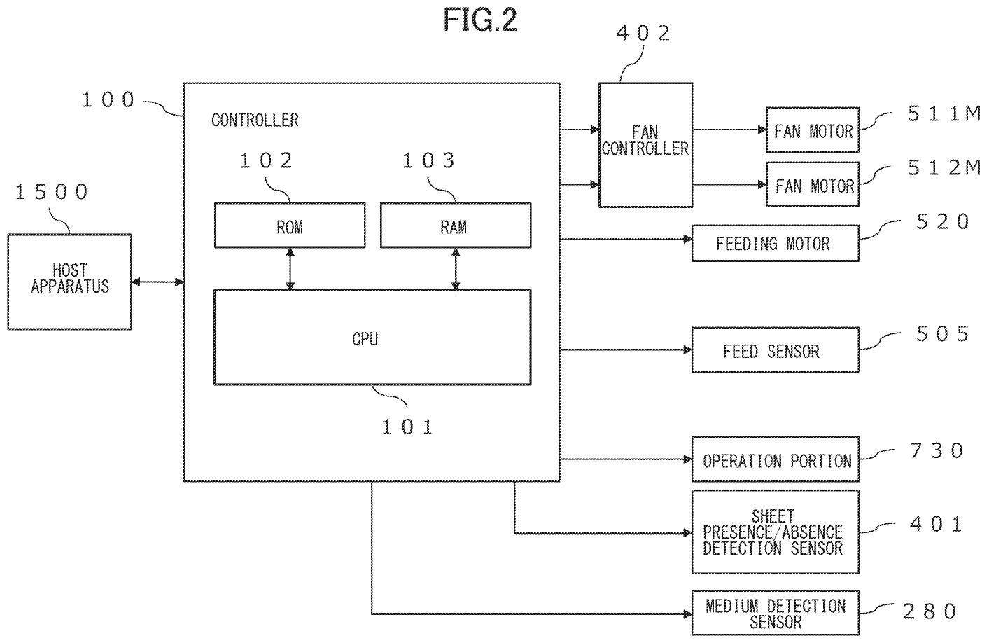

Next, an image forming operation of the image forming apparatus 201 will be described. First, for example, when image information of a document is read by the image reading apparatus 202, the image information is subjected to image processing and then converted into an electric signal to be transmitted to the laser scanner 210 of the image forming portion 201B. The image information may be transmitted from a host apparatus 1500 (see FIG. 2) such as an external computer via a network.

In the image forming portion 201B, the surface is uniformly charged to have a predetermined polarity and potential by the charger 213, and the surfaces of the photosensitive drums 212 are sequentially exposed by a laser beam. As a result, electrostatic latent images of yellow, magenta, cyan, and black are sequentially formed on the photosensitive drums of the process cartridges 211.

After that, these electrostatic latent images are visualized by developing them with the respective color toners, and the toner images of the respective colors on the respective photoconductor drums are sequentially superimposed and transferred onto the intermediate transfer belt 216 by the primary transfer bias applied to the primary transfer roller 219. As a result, a toner image is formed on the intermediate transfer belt 216.

On the other hand, a sheet S fed from the sheet feeding unit 230 (or the manual feed portion 235 or the feeding deck 800) is conveyed to a registration roller pair 240 including a driving roller and a driven roller. At this time, the registration roller pair 240 is not driven and stopped, and the leading end of the sheet S abuts on the registration roller pair 240. As a result, the leading end of the sheet S is aligned with the registration roller pair 240.

Since the feed roller 3 (or the feed roller 502 or the feed roller 802) or the like continues to convey the sheet S after that, the sheet S is deflected (looped). Then, the registration roller pair 240 is driven in accordance with the timing of the toner image on the intermediate transfer belt 216. As a result, skew feeding of the sheet S is corrected by the registration roller pair 240, and the sheet S whose skew feeding has been corrected is conveyed to the secondary transfer portion 201D by the registration roller pair 240.

Subsequently, in the secondary transfer portion 201D, the toner images are collectively transferred onto the sheet S by the secondary transfer bias applied to the secondary transfer roller 217. The sheet S with the toner images transferred thereon is conveyed to the fixing portion 201E. In the fixing portion 201E, heat and pressure are applied to the sheet S so that the toners of different colors melt and mix, and fix onto the sheet S as a color image.

Thereafter, the sheet S on which the image has been fixed is discharged to the discharge space V by the first or second sheet discharge roller pair 225a or 225b provided downstream of the fixing portion 201E, and is stacked on the stacking portion 223 formed on the bottom of the discharge space V. When an image is to be formed on both sides of the sheet S, after the images are fixed, the sheet S is conveyed to the re-conveyance path R by the reverse conveyance roller pair 222 and is conveyed to the secondary transfer portion 201D again.

### Configuration of Manual Feed Portion

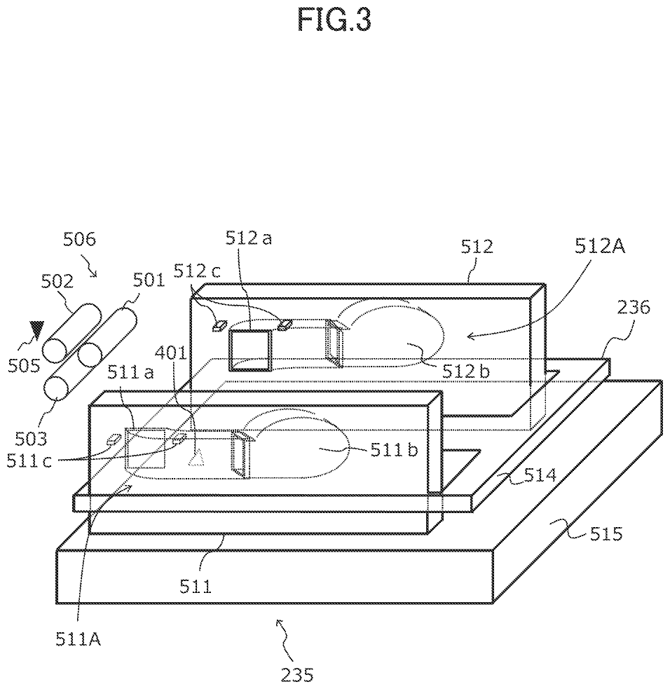

Next, details of the manual feed portion 235 as the sheet feeding apparatus will be described with reference to FIGS. 1 and 3. FIG. 3 is a schematic diagram illustrating a configuration of the manual feed portion 235 according to the first embodiment.

As illustrated in FIGS. 1 and 3, the manual feed portion 235 includes the sheet feeding tray 236 as a supporting portion, and the sheet feeding portion 506 as a feeding portion that feeds sheets and separates sheets fed in a bundle. The sheet feeding portion 506 includes the pickup roller 501 as a feeding roller that abuts on the uppermost sheet of the sheet bundle to feed the uppermost sheet. Further, the sheet feeding portion 506 includes the feed roller 502 and retard roller 503 as a separating unit that separates sheets S fed from the pickup roller 501.

In addition, in the manual feed portion 235, a drawing roller pair 504 that draws the sheet S from the feed roller 502 and feeds the sheet S to the image forming apparatus 201 is disposed downstream of the feed roller 502 in the sheet feeding direction. A feed sensor 505 is disposed between the feed roller 502 and the drawing roller pair 504 in the sheet feeding direction, that is, downstream of the sheet feeding portion 506 in the feeding direction. The feed sensor 505 detects the passage of the sheet S by outputting a signal depending on the presence/absence of the sheet S.

As illustrated in FIG. 3, the sheet feeding tray 236 includes a manual feed tray base 515, and a lifter plate 514 that supports a sheet bundle formed by the plurality of sheets S. The lifter plate 514 includes a sheet presence/absence detection sensor 401 as a sheet detection portion that detects that the sheet S is supported on the sheet feeding tray 236. The position of the lifter plate 514 in the height direction is controlled by a lifting mechanism (not illustrated) according to the amount of sheets S supported.

As illustrated in FIG. 3, the sheet feeding tray 236 is provided with side end regulating plates 511 and 512 that regulate the position of the sheet S supported by the sheet feeding tray 236 in the width direction orthogonal to the feeding direction. The side end regulating plates 511 and 512 restrict the positions of the end portions (side ends of the sheet) in the width direction of the sheet S set on the lifter plate 514. Each of the side end regulating plates 511 and 512 is provided with an air blowing portion 511A or 512A as a separating portion. The air blowing portion 511A includes a fan 511b driven by a fan motor 511M (see FIG. 2), and a duct 511a that guides the air blown in from the fan 511b to flow through the inside of the side end regulating plate 511 to blow the sheet bundle from one side. Similarly, the air blowing portion 512A includes a fan 512b driven by a fan motor 512M (see FIG. 2), and a duct 512a that guides the air blown in from the fan 512b to flow through the inside of the side end regulating plate 512 to blow the sheet bundle from another side. Further, the side end regulating plates 511 and 512 are provided with floating prevention plates 511c and 512c near the openings of the ducts 511a and 512a to prevent the sheet S blown with air from floating and getting over the side end regulating plates 511 and 512.

### Configuration of Control System of Image Forming System

Next, a configuration of a control system in the image forming system 600 will be described with reference to FIG. 2. FIG. 2 is a block diagram of the control system of the image forming system according to the first embodiment.

A controller 100 according to the present embodiment is provided in the image forming apparatus 201, for example, and includes a CPU 101, a ROM 102, and a RAM 103. The controller 100 is a control member that collectively controls the image forming apparatus 201, the feeding deck 800, and the manual feed portion 235. The controller 100 is connected to the host apparatus 1500 and the operation portion 730, and performs signal processing, sequence control, and the like for various process devices while exchanging information with the host apparatus 1500 and the operation portion 730. Note that the host apparatus 1500 is an external device such as a personal computer, an image scanner, or a facsimile. The controller 100 is also connected to a fan controller 402, a feeding motor 520 as a motor that drives the pickup roller 501, the feed sensor 505, the medium detection sensor 280, and the like.

### Operation during Air Blowing

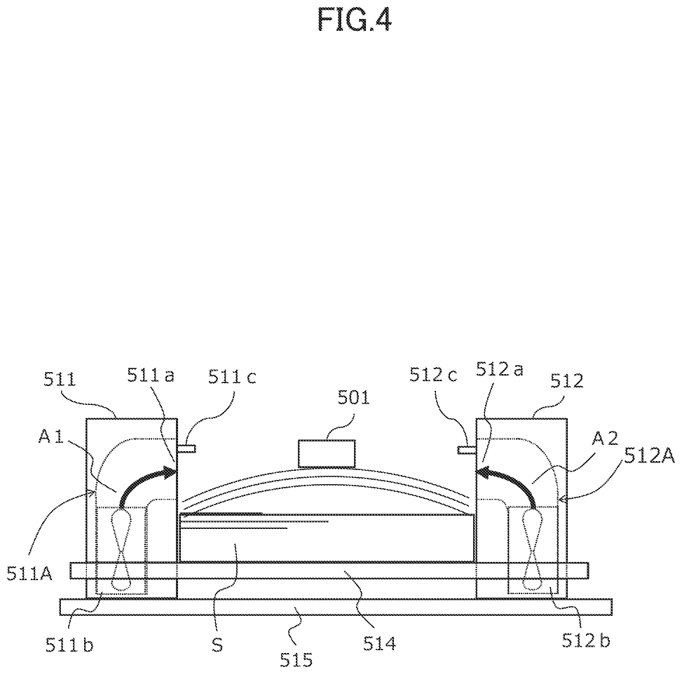

Next, the operation when air is blown from the sides of the sheet bundle by the air blowing portions 511A and 512A will be described with reference to FIG. 4. FIG. 4 is a schematic diagram illustrating a state in which the air blowing operation is performed in the manual feed portion 235 according to the first embodiment.

As illustrated in FIG. 4, when the controller 100 starts the air blowing operation, the fans 511b and 512b of the air blowing portions 511A and 512A blow air toward the side faces of the sheet bundle as indicated by arrows A1 and A2. Then, the upper several to several tens of sheets S of the sheet bundle are separated and float. The floating of the separated sheets S is suppressed by the uppermost sheet S abutting on the floating prevention plates 511c and 512c. As a result, the adhesion between those sheets S is reduced, and the sheets S can be fed by the conveying force of the pickup roller 501 even when they are sheets S having smooth surface property such as coated paper.

### Configuration of Medium Detection Sensor

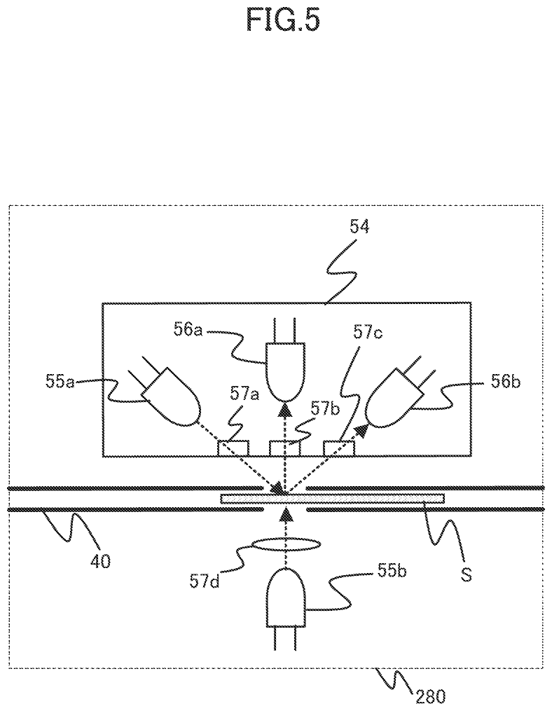

Next, a configuration of the medium detection sensor will be described with reference to FIG. 5. FIG. 5 is a cross-sectional view illustrating the configuration of the medium detection sensor 280 according to the first embodiment.

As shown in FIG. 5, the medium detection sensor 280 is a sensor that detects the type of the sheet, and includes a main unit 54 and an external LED 55b that is an external irradiation member. The main unit 54 includes an LED 55a, a phototransistor 56a, and a phototransistor 56b in the unit.

### Detection of Sheet Surface Property by Medium Detection Sensor

Next, detection of the surface property of the sheet S (corresponding to the medium) by the medium detection sensor 280 will be described. As illustrated in FIG. 5, light from the LED 55a as a light source is emitted through a slit 57a to the surface of a sheet S that is on the sheet conveyance guide 40. The sheet conveyance guide 40 is provided with a window for irradiating the sheet S with light from the back side of the sheet S. Reflected light from the sheet S is concentrated through slits 57b and 57c and received by the phototransistors 56a and 56b. For the light from the LED 55a as a light source, the phototransistor 56a acquires a diffuse reflection output value, and the phototransistor 56b acquires a specular reflection output value. A value x of the surface property is obtained as a ratio of the specular reflection output value to the diffuse reflection output value (surface property value x =specular reflection output/diffuse reflection output).

That is, for example, the surface property is quantified as the value x by utilizing the characteristic that light is likely to be specularly reflected when the surface property is smooth. That is, a computing apparatus (not shown) disposed in the medium detection sensor 280 performs the above calculation to quantify the surface property of the sheet S and notifies the CPU 101 of the calculation result. The CPU 101 determines the surface property using the notified surface property value x and a threshold for determining the surface property. If the value x of the surface property is higher than the threshold, it is determined that the type is “smooth” indicating that the surface property is smooth, and if the value x of the surface property is lower than the threshold value, it is determined that the type is “rough” indicating that the surface property is rough. Although a single threshold value is used in the present embodiment, a plurality of thresholds may be used to classify the surface property of the sheet S into a larger number of types.

### Detection of Sheet Thickness by Medium Detection Sensor

Next, detection of the thickness of the sheet will be described. Light from an external LED 55b as a light source is emitted to the back side of a sheet P through a condenser guide 57d for concentrating the light. Light that has passed through the sheet P is received by the phototransistor 56a through the slit 57b. The phototransistor 56a acquires a regular transmission output value for the light from the external LED 55b as a light source. Thus, the transmittance of the sheet S is detected.

The thickness of the sheet S is detected using the transmittance by utilizing the characteristic that the thicker the sheet, the lower the transmittance, and the thinner the sheet, the higher the transmittance. The detected transmittance is sent to the CPU 101. The CPU 101 classifies the thickness using the notified transmittance value and a threshold for classifying the thickness. Since the thickness is classified into three types, namely, “thick”, “normal”, and “thin” in the present embodiment, thickness classifying thresholds A and B are used. If the detected transmittance is higher than the thickness classifying threshold A, it is determined to be the “thin” type. If the detected transmittance is lower than the thickness classifying threshold B, it is determined to be “thick” type. If neither of these are applicable, it is determined to be the “normal” type.

Although two thresholds are used in the present embodiment, as another embodiment, a single threshold may be used to classify the thickness into two types, or three or more thresholds may be used to classify the thickness into a larger number of types. Further, although an optical sensor is used in the present embodiment, the present technology is not limited thereto. Another kind of sensor such as an ultrasonic sensor may be used as long as the sensor can detect the surface property or the thickness.

### Control of Image Forming Apparatus According to First Embodiment

Next, control performed when an image is formed by feeding the sheet S from the manual feed portion 235 in the image forming apparatus 201 according to the first embodiment will be described with reference to the drawings. As this control of the image forming apparatus 201, in general, control performed when the power is turned on (when waking up from the power saving mode), control performed when the sheet is set in the manual feed portion 235, and control performed when a job is input will be described in order.

### Control Performed When Power is Turned On

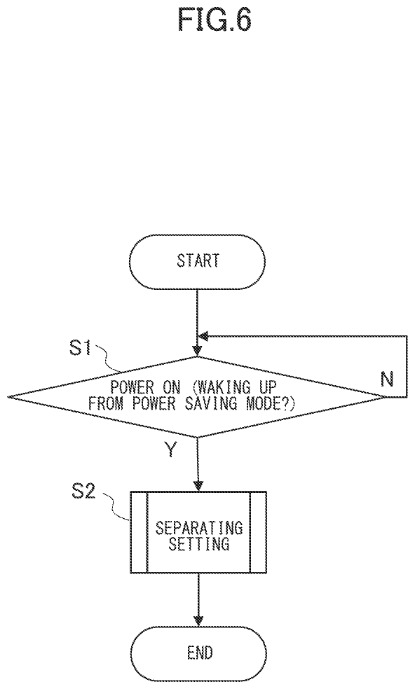

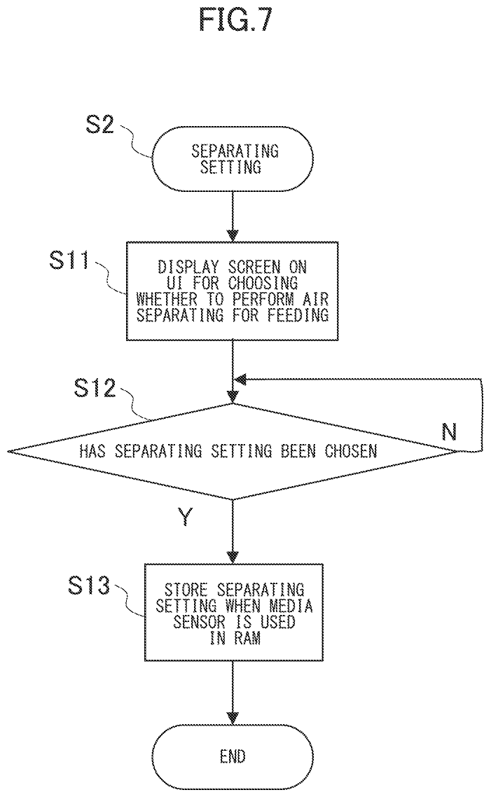

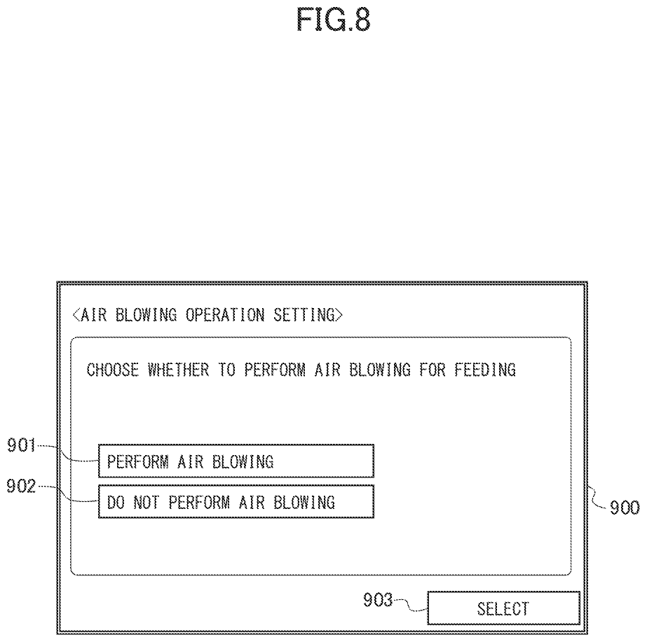

First, the control performed when the power is turned on by the user or when the apparatus wakes up from the power saving mode will be described with reference to FIGS. 6, 7, and 8. FIG. 6 is a flowchart illustrating a process carried out when the power is turned on according to the first embodiment. FIG. 7 is a flowchart illustrating a process of separating setting according to the first embodiment. FIG. 8 is a view illustrating a setting screen of the air blowing operation according to the first embodiment.

As illustrated in FIG. 6, in the control performed when the power is turned on, the controller 100 stands by until, for example, the power switch of the image forming apparatus 201 is turned on or until an instruction to wake up from the power saving mode is given (for example, a power saving mode switch is pushed) (N in S1). When it is detected that the power has been turned on or that the instruction to wake up from the power saving mode has been given (Y in S1), the separating setting process (S2) is performed as a setting process performed when the medium detection sensor 280 is used (medium sensor mode to be described later). Then, the control performed when the power is turned on is terminated.

As illustrated in FIG. 7, when the separating setting process (S2) starts, first, as illustrated in FIG. 8, the controller 100 displays on the operation portion 730 an air blowing operation setting screen 900 to be used when the medium detection sensor 280 is used (S11). That is, as will be described in detail later, the air blowing operation setting screen 900 is a screen for choosing whether or not to perform the air blowing (air separation) when feeding the first sheet feeding in the medium sensor mode for detecting the type of the sheet S by the medium detection sensor 280. That is, in step S11, the user is prompted to choose the separating setting for the feeding of the first sheet in the medium sensor mode, and whether the separating setting has been chosen is determined (S12).

In this procedure of choosing the separating setting, when the user pushes either a button 901 for performing air blowing or a button 902 for not performing air blowing and further pushes a select button 903, it is determined that the separating setting has been chosen (Y in S12). That is, a driven state (the button 901 for performing air blowing is pushed) or undriven state (the button 902 for not performing air blowing is pushed) can be chosen for the air blowing operation during feeding of the first sheet in the medium sensor mode. If the separating setting has not been chosen, the process waits repeatedly until the separating setting is chosen (N in S12).

When the separating setting has been chosen (Y in S12), the process proceeds to step S13 and stores the chosen separating setting in the RAM 103. That is, when the button 901 for performing air blowing is pushed, the separating setting is stored in the RAM 103 as ON. That is, when the button 902 for not performing air blowing is pushed, the separating setting is stored in the RAM 103 as OFF. Then, the control performed when the power is turned on (when waking up from the power saving mode) is ended.

### Control Performed When Sheet is Set in Manual Feed Portion

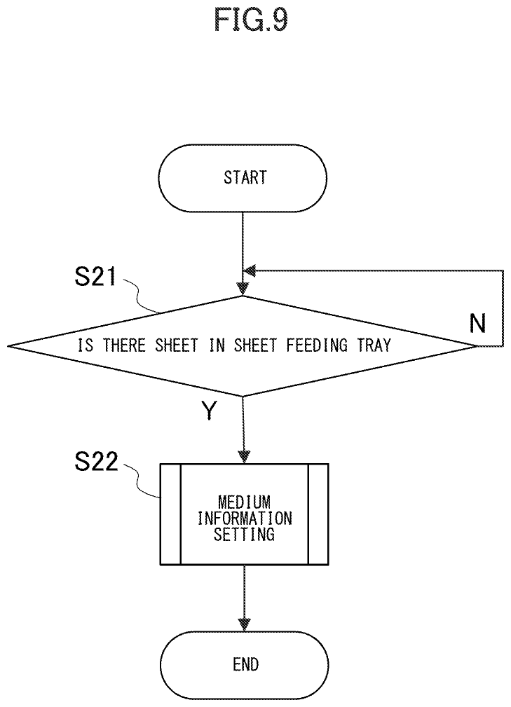

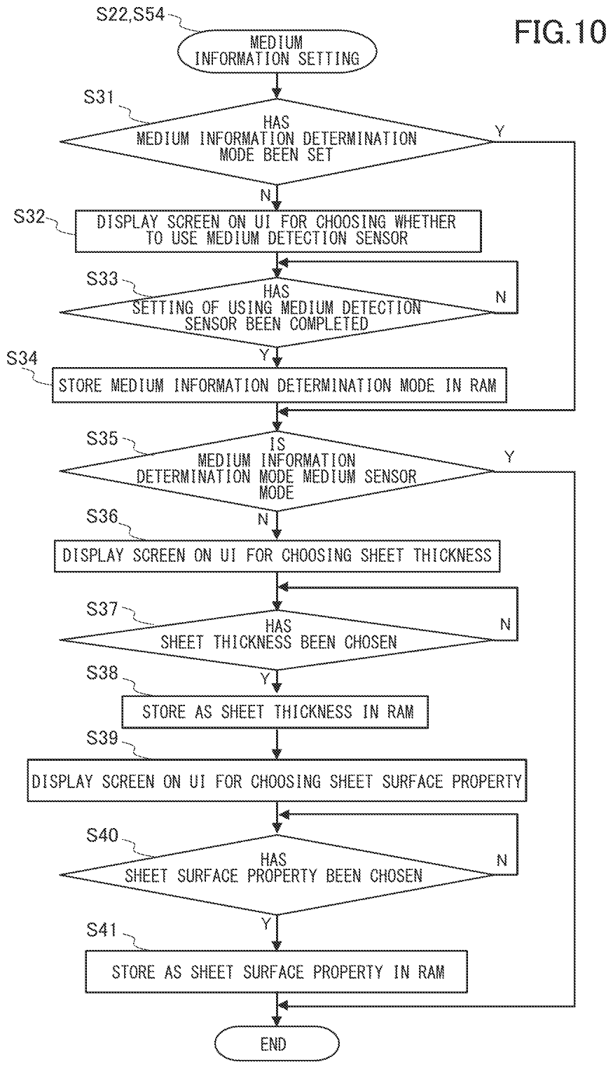

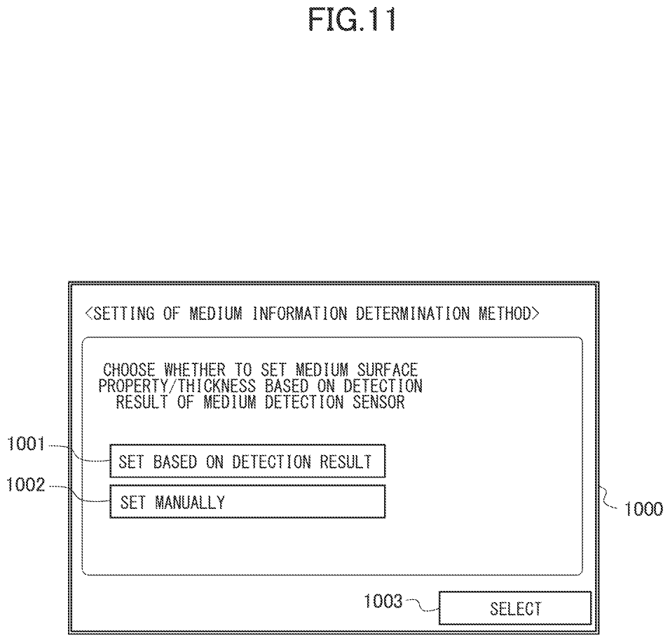

Next, control performed in the case where a sheet is set in the manual feed portion will be described with reference to FIGS. 9, 10, 11, 12, and 13. FIG. 9 is a flowchart illustrating a process performed in the case where a sheet is set in the sheet feeding tray 236 according to the first embodiment. FIG. 10 is a flowchart illustrating a medium information setting process according to the first embodiment. FIG. 11 is a view illustrating a screen for setting a medium information determination method according to the first embodiment. FIG. 12 is a view illustrating a screen for setting the sheet thickness according to the first embodiment. FIG. 13 is a view illustrating a screen for setting the sheet surface property according to the first embodiment.

As illustrated in FIG. 9, when the control performed in the case where a sheet is set in the manual feed portion is started, the controller 100 first detects whether or not there is a sheet S in the sheet feeding tray 236 of the manual feed portion 235 (S21). Whether or not there is a sheet S in the sheet feeding tray 236 can be detected by the above-described sheet presence/absence detection sensor 401 or the like. The controller 100 stands by until the sheet S is set in the sheet feeding tray 236 (N in S21), and when it is detected that the sheet S is set in the sheet feeding tray 236 (Y in S21), the medium information setting process (S22) is executed. Then, this control is terminated.

As illustrated in FIG. 10, when the medium information setting process (S22) is started, first, it is determined whether the medium information determination mode has been set (S31). This is determined based on whether the medium information determination mode is stored in the RAM 103. If the medium information determination mode is stored (Y in S31), the process proceeds to step S35 to be described later. If the medium information determination mode is not stored (N in S31), the process proceeds to step S32.

If the medium information determination mode is not stored, the control proceeds to step S32 in which, as illustrated in FIG. 11, a screen 1000 for setting the medium information determination method is displayed on the operation portion 730 as a choosing process for choosing whether or not to use the medium detection sensor 280. That is, the screen 1000 for setting the medium information determining method is a screen for setting whether or not the mode is the medium sensor mode as a first mode in which the type of the sheet S is detected and set by the medium detection sensor 280 while the sheet S is being fed. In other words, the screen 1000 for setting the medium information determination method is a screen for setting whether or not the mode is the user setting mode as a second mode in which the sheet type is set using the information input by the operation portion 730 and feeding is performed. That is, in step S32, the user is prompted to choose the medium sensor mode or the user setting mode on the screen 1000 for setting the medium information determination method, and in step S33, it is determined whether the setting has been completed (S33).

The setting as to whether or not to use the medium detection sensor 280 is completed when the user pushes, on the screen 1000 for setting the medium information determination method, a button 1001 for setting based on a detection result or a button 1002 for manual setting, and further pushes a select button 1003. In other words, if the setting as to whether or not to use the medium detection sensor 280 (that is, the medium information determination mode) is not chosen, the process repeatedly stands by until the it is chosen (N in S33).

When the setting as to whether or not to use the medium detection sensor 280 (that is, the medium information determination mode) has been chosen (Y in S33), the choice made in step S33 is stored in the RAM 103 as the medium information determination mode (S34). That is, in a case where the user pushes the button 1001 for setting based on the detection result in step S33, the medium sensor mode in which the medium detection sensor 280 is used is stored in the RAM 103. On the other hand, in a case where the user pushes the button 1002 for manual setting, the user setting mode in which the medium detection sensor is not used is stored in the RAM 103.

Subsequently, in step S35, it is determined whether or not the setting of the medium information determination mode stored in the RAM 103 is the medium sensor mode. When the setting of the medium information determination mode is the medium sensor mode (Y in S35), this control ends. On the other hand, when the setting of the medium information determination mode is the user setting mode (N in S35), the process proceeds to step S36 in which and the user manually sets the thickness type and the surface property type (that is, the sheet information) of the sheet S.

In step S36, first, as illustrated in FIG. 12, a sheet thickness setting screen 1100 is displayed on the operation portion 730. When the user pushes one of the thin sheet button 1101, the regular sheet button 1102, and the thick sheet button 1103, and further pushes the select button 1104, the choice of the sheet thickness type is completed. That is, if the sheet thickness type has not been chosen, the process waits repeatedly until it is chosen (N in S37).

When the sheet thickness has been chosen (Y in S37), the sheet thickness is stored in the RAM 103 (S38). That is, in step S37, the thin sheet is stored when the thin sheet button 1101 has been pushed, the regular sheet is stored when the regular sheet button 1102 has been pushed, and the thick sheet is stored when the thick sheet button 1103 has been pushed. Although three types of buttons are used to choose the thickness in the present embodiment, the present technology is not limited thereto, and the thickness may be selected from two types or four or more types.

In step S39, as illustrated in FIG. 13, a screen 1200 for setting the sheet surface property is displayed on the operation portion 730. Then, when the user pushes one of a “fine” button 1201, a standard button 1202, and a “rough” button 1203, and further pushes a select button 1204, the choice of the sheet surface property type is completed. Here, “fine” means “smooth”, for example. That is, if the sheet surface property type has not been chosen, the process waits repeatedly until it is chosen (N in S40).

When the sheet surface property type has been chosen (Y in S40), the sheet surface property is stored in the RAM 103 (S41). That is, in step S40, fine is stored when the fine button 1201 has been pushed, standard is stored when the standard button 1202 has been pushed, and rough is stored when the rough button 1203 has been pushed. Then, the medium information setting process (S22) ends. Although three types of buttons are used to choose the surface property in the present embodiment, the present technology is not limited thereto, and the thickness may be selected from two types or four or more types.

### Control Performed When Job is Input

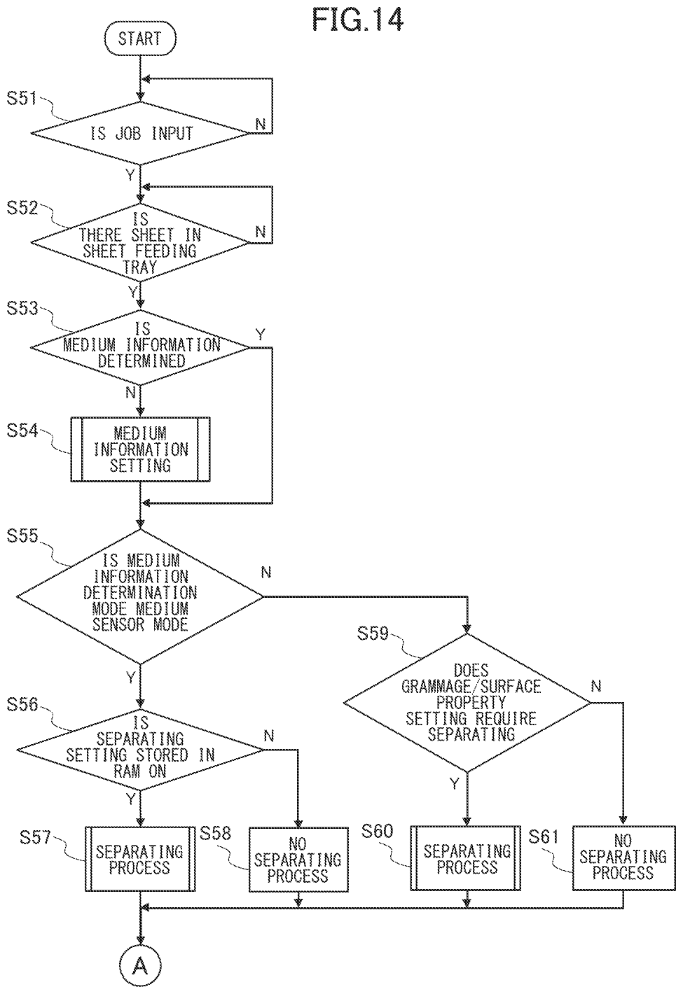

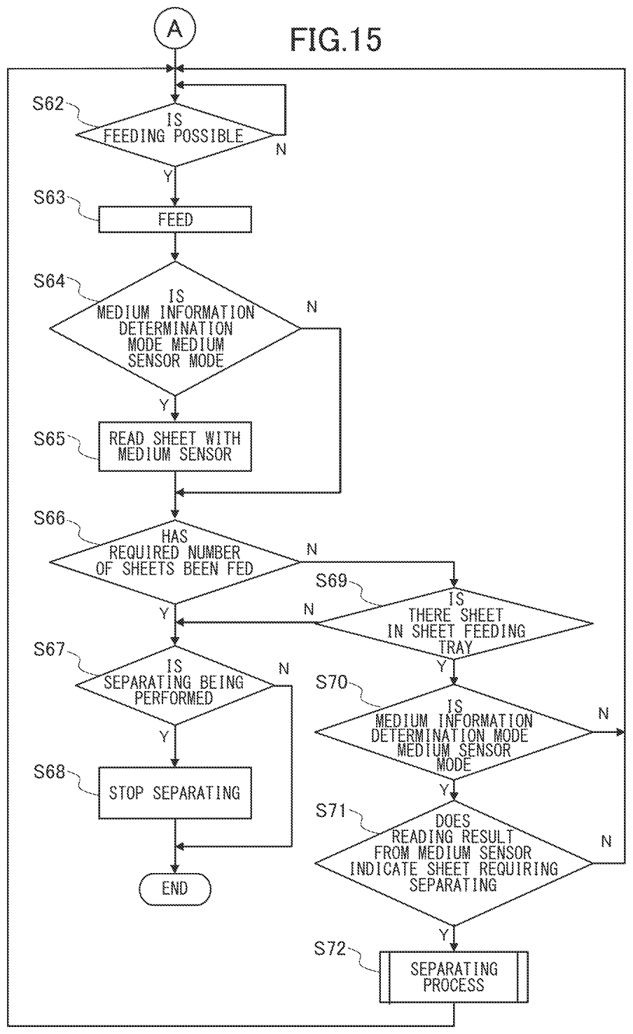

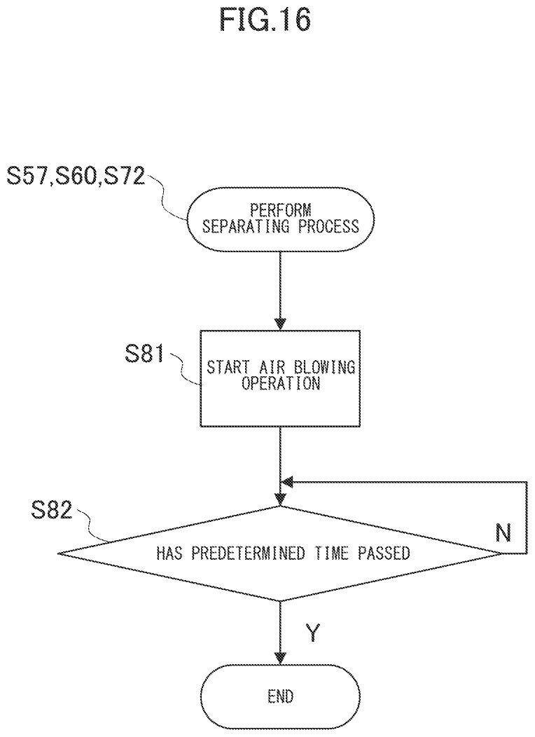

Next, control performed in a case where a job is input will be described with reference to FIGS. 14, 15, and 16. FIG. 14 is a flowchart illustrating part of a process performed in the case where a job is input according to the first embodiment. FIG. 15 is a flowchart illustrating the following steps of the process performed in the case where a job is input according to the first embodiment. FIG. 16 is a flowchart illustrating the separating process according to the first embodiment.

As illustrated in FIG. 14, for example, the controller 100 waits until a print job (hereinafter, simply referred to as a “job”) for performing image formation (printing) on a plurality of sheets S is input (N in S51). Whether or not a job has been input is determined based on whether or not there is a job request from the host apparatus 1500. When the job is input (Y in S51), the process proceeds to step S52.

In step S52, the controller 100 determines whether there are sheet S in the sheet feeding tray 236 of the manual feed portion 235. A sheet presence/absence detection member such as the sheet presence/absence detection sensor 401 described above is used to determine whether there are sheets S in the sheet feeding tray 236. The process waits until the sheets S are set in the sheet feeding tray 236 (N in S52), and when the sheets S are set (have already been set) (Y in S52), the process proceeds to step S53.

In step S53, the controller 100 determines whether the medium information has been determined. The medium information determination mode stored in the RAM 103 is used for this determination (see S34 in FIG. 10). In a case where the medium information determination mode is set to the medium sensor mode or the user setting mode, it is determined that the medium information has been determined (Y in S53), and the control proceeds to step S55. In a case where it is determined that the medium information has not been determined (N in S53), the subroutine of the medium information setting process (S54) illustrated in FIG. 10 described above is executed, and the control proceeds to step S55.

In step S55, the controller 100 determines whether or not the medium information determination mode stored in the RAM 103 is the medium sensor mode. In a case where the medium information determination mode is the medium sensor mode (Y in S55), the control proceeds to step S56, and thereafter, the sheet feeding operation is performed as the medium sensor mode. In addition, in a case where the medium information determination mode is the user setting mode (N in S55), the control proceeds to step S59, and thereafter, the sheet feeding operation is performed as the user setting mode.

### When Air Separation is Performed in User Setting Mode

First, the feeding operation in a case where the medium information determination mode is the user setting mode and air separation is performed will be described. In step S59, it is determined whether air separation is necessary according to the thickness type and the surface property type of the sheet S set by the user and stored in the RAM 103 in the medium information setting process (S22, S54). In a case where the set sheet S type is thin paper, regular paper, or the like having a fine surface property and a small thickness, and thus prone to being fed in a bundle (Y in S59), it is determined that air separation is necessary, and the control proceeds to the separating process in step S60.

In step S60, as illustrated in FIG. 16, the separating process is started, and the fans 511b and 512b of the air blowing portions 511A and 512A are driven to start the air blowing operation (S81). Then, the process waits until a predetermined time (for example, 10 seconds) elapses so that the sheets S set in the sheet feeding tray 236 are sufficiently fanned (N in S82). When the predetermined time elapses (Y in S82), the separating process ends.

When the separating process in step S60 has ended, as illustrated in FIG. 15, the process proceeds to step S62 in which the controller 100 determines whether feeding is possible. Whether feeding is possible is determined based on whether a sheet S is detected by the feed sensor 505 (see FIGS. 2 and 3). That is, in the state in which a sheet S is detected by the feed sensor 505, it is determined that a sheet cannot be fed due to the presence of the previous sheet, and the process waits until the sheet S can be fed (N in S62). Then, when it is determined that the sheet S is no longer detected by the feed sensor 505, that is, the previous sheet has gone and a new sheet can be fed (Y in S62), the sheet S is fed with the pickup roller 501 (S63).

Next, it is determined again whether the medium information determination mode is the medium sensor mode (S64). Here, since the medium information determination mode is the user setting mode (N in S64), it is determined whether the number of sheets required to be fed in the job has been fed (S66). If the necessary number of sheets has not been fed (N in S66), it is determined again whether there are sheets S in the sheet feeding tray 236 (S69) as in step S52. If there are sheets S in the sheet feeding tray 236 (Y in S69), it is further determined whether the medium information determination mode is the medium sensor mode (S70). Here, since the medium information determination mode is the user setting mode (N in S70), the process returns to step S62.

This feeding operation is repeated, and once when the number of sheets required to be fed in the job has been fed (Y in S66) or when there is no sheet S left in the sheet feeding tray 236 (N in S69), it is determined whether or not the separating process (the above-described S60) is being performed (S67). Here, since the separating process is being performed (Y in S67), the fans 511b and 512b of the air blowing portions 511A and 512A are stopped to stop the air blowing operation (S68), whereby the sheet feeding operation in the case the air separation is performed in the user setting mode is terminated.

### When Air Separation is not Performed in User Setting Mode

Next, the feeding operation in a case where the medium information determination mode is the user setting mode and air separation is not performed will be described. When the process reaches step S59 shown in FIG. 14 as described above, it is determined whether air separation is necessary according to the thickness type and the surface property type of the sheet S set by the user and stored in the RAM 103 in the medium information setting process (S22, S54). In a case where the sheets S are not prone to being fed in a bundle, that is, if they are not thin paper, regular paper, or the like having a fine surface property and a small thickness (N in S59), it is determined that air separation is unnecessary, and the process proceeds to S61. In step S61, nothing is particularly performed on the fans 511b and 512b of the air blowing portions 511A and 512A described above, and the process proceeds to step S62 illustrated in FIG. 15.

In step S62, the controller 100 determines whether a sheet can be fed as described above, and in a case where it is determined that the sheet cannot be fed due to the presence of the previous sheet, the controller waits until it can be fed (N in S62). Then, when it is determined that the previous sheet has gone and a new sheet can be fed (Y in S62), the sheet S is fed with the pickup roller 501 (S63).

Next, it is determined again whether the medium information determination mode is the medium sensor mode (S64). Here, since the medium information determination mode is the user setting mode (N in S64), it is determined whether the number of sheets required to be fed in the job has been fed (S66). If the necessary number of sheets has not been fed (N in S66), it is determined again whether there are sheets S in the sheet feeding tray 236 (S69) as in step S52. If there are sheets S in the sheet feeding tray 236 (Y in S69), it is further determined whether the medium information determination mode is the medium sensor mode (S70). Here, since the medium information determination mode is the user setting mode (N in S70), the process returns to step S62.

This feeding operation is repeated, and once when the number of sheets required to be fed in the job has been fed (Y in S66) or when there is no sheet S left in the sheet feeding tray 236 (N in S69), it is determined whether or not the separating process (the above-described S60) is being performed (S67). Since the separating process is not executed here (N in S67), the sheet feeding operation in the case where the air separation is not executed in the user setting mode ends immediately.

### When Air Separation is Performed for First Sheet Feeding in Medium Sensor Mode

Nest, the sheet feeding operation in a case where the medium information determination mode is the medium sensor mode and air separation is performed for the first sheet feeding will be described. If the medium information determination mode stored in the RAM 103 is the medium sensor mode in step S55 shown in FIG. 14 described above (Y in S55), the process proceeds to step S56. In step S56, it is determined whether or not the separating setting chosen by the user and stored in the RAM 103 in the separating setting process (S2 described above) is ON. Here, assuming that the separating setting chosen by the user and stored in the RAM 103 is ON (Y in S56), the process proceeds to the separating process in step S57.

In step S57, as illustrated in FIG. 16, the separating process is started, and the fans 511b and 512b of the air blowing portions 511A and 512A are driven to start the air blowing operation (S81). Then, the process waits until a predetermined time (for example, 10 seconds) elapses so that the sheets S set in the sheet feeding tray 236 are sufficiently fanned (N in S82). When the predetermined time elapses (Y in S82), the separating process ends.

When the separating process in step S57 has ended, the process proceeds to step S62 illustrated in FIG. 15 in which the controller 100 determines whether feeding is possible. Whether feeding is possible is determined based on whether a sheet S is detected by the feed sensor 505 (see FIGS. 2 and 3). That is, in the state in which a sheet S is detected by the feed sensor 505, it is determined that a sheet cannot be fed due to the presence of the previous sheet, and the process waits until the sheet S can be fed (N in S62). Then, when it is determined that the sheet S is no longer detected by the feed sensor 505, that is, the previous sheet has gone and a new sheet can be fed (Y in S62), the sheet S is fed with the pickup roller 501.

Next, it is determined again whether the medium information determination mode is the medium sensor mode (S64). Here, since the medium information determination mode is the medium sensor mode (Y in S64), the medium detection sensor 280 reads the sheet S (S65). That is, for the first sheet S fed by the pickup roller 501, the detection of the surface property and the detection of the thickness by the medium detection sensor 280 are executed as described above.

Subsequently, it is determined whether or not the number of sheets required to be fed in the job has been fed (S66). If the necessary number of sheets has not been fed (N in S66), it is determined again whether there are sheets S in the sheet feeding tray 236 (S69) as in step S52. If there are sheets S in the sheet feeding tray 236 (Y in S69), it is further determined whether the medium information determination mode is the medium sensor mode (S70). Here, since the medium information determination mode is the medium sensor mode (Y in S70), the process proceeds to step S71.

Then, in step S71, based on the surface property and the thickness of the sheet S detected by the medium detection sensor 280, it is determined whether or not the sheet is a sheet that requires the air separation operation. In a case where the sheet S type detected by the medium detection sensor 280 is thin paper, regular paper, or the like having a fine surface property and a small thickness, and thus prone to being fed in a bundle, it is determined that air separation is necessary (Y in S71), and the control proceeds to the separating process in step S72. Subsequently, the fans 511b and 512b of the air blowing portions 511A and 512A are driven to perform the air blowing operation, and the process returns to step S62.

On the other hand, when the type of the sheet S detected by the medium detection sensor 280 is another sheet type, it is determined that air separation is not necessary (N in S71). In this case, the fans 511b and 512b of the air blowing portions 511A and 512A are stopped to stop the air blowing operation, and the process returns to step S62.

This feeding operation is repeated, and once when the number of sheets required to be fed in the job has been fed (Y in S66) or when there is no sheet S left in the sheet feeding tray 236 (N in S69), it is determined whether or not the separating process (the above-described S60) is being performed (S67). Here, in a case where the separating process is being performed (Y in S67), the fans 511b and 512b of the air blowing portions 511A and 512A are stopped to stop the air blowing operation (S68), whereby the sheet feeding operation in the medium sensor mode is terminated. In addition, in a case where the separating process is already not being executed (N in S67), the sheet feeding operation in the medium sensor mode is ended immediately.

### When Air Separation is not Performed for First Feeding in Medium Sensor Mode

Nest, the sheet feeding operation in a case where the medium information determination mode is the medium sensor mode and air separation is not performed for the first sheet feeding will be described. If the medium information determination mode stored in the RAM 103 is the medium sensor mode in step S55 shown in FIG. 14 described above (Y in S55), the process proceeds to step S56. In step S56, it is determined whether or not the separating setting chosen by the user and stored in the RAM 103 in the separating setting process (S2 described above) is ON. Here, assuming that the separating setting chosen by the user and stored in the RAM 103 is OFF (N in S56), the process proceeds step S58. In step S58, nothing is particularly performed on the fans 511b and 512b of the air blowing portions 511A and 512A described above, and the process proceeds to step S62 illustrated in FIG. 15.

In step S62, the controller 100 determines whether feeding is possible. Whether feeding is possible is determined based on whether a sheet S is detected by the feed sensor 505 (see FIGS. 2 and 3). That is, in the state in which a sheet S is detected by the feed sensor 505, it is determined that a sheet cannot be fed due to the presence of the previous sheet, and the process waits until the sheet S can be fed (N in S62). Then, when it is determined that the sheet S is no longer detected by the feed sensor 505, that is, the previous sheet has gone and a new sheet can be fed (Y in S62), the sheet S is fed with the pickup roller 501.

Next, it is determined again whether the medium information determination mode is the medium sensor mode (S64). Here, since the medium information determination mode is the medium sensor mode (Y in S64), the medium detection sensor 280 reads the sheet S (S65). That is, for the first sheet S fed by the pickup roller 501, the detection of the surface property and the detection of the thickness by the medium detection sensor 280 are executed as described above.

Subsequently, it is determined whether or not the number of sheets required to be fed in the job has been fed (S66). If the necessary number of sheets has not been fed (N in S66), it is determined again whether there are sheets S in the sheet feeding tray 236 (S69) as in step S52. If there are sheets S in the sheet feeding tray 236 (Y in S69), it is further determined whether the medium information determination mode is the medium sensor mode (S70). Here, since the medium information determination mode is the medium sensor mode (Y in S70), the process proceeds to step S71.

Then, in step S71, based on the surface property and the thickness of the sheet S detected by the medium detection sensor 280, it is determined whether or not the sheet is a sheet that requires the air separation operation. In a case where the sheet S type detected by the medium detection sensor 280 is thin paper, regular paper, or the like having a fine surface property and a small thickness, and thus prone to being fed in a bundle, it is determined that air separation is necessary (Y in S71), and the control proceeds to the separating process in step S72. In this case, although the air separation operation was not performed for the first sheet feeding, since air separation is necessary, the fans 511b and 512b of the air blowing portions 511A and 512A are driven to start the air blowing operation. The process then returns to step S62.

On the other hand, when the type of the sheet S detected by the medium detection sensor 280 is another sheet type, it is determined that air separation is not necessary (N in S71). In this case, the fans 511b and 512b of the air blowing portions 511A and 512A remain stopped. In other words, the air blowing operation is not performed, and the process returns to step S62.

This feeding operation is repeated, and once when the number of sheets required to be fed in the job has been fed (Y in S66) or when there is no sheet S left in the sheet feeding tray 236 (N in S69), it is determined whether or not the separating process (the above-described S60) is being performed (S67). Here, in a case where the separating process is being performed (Y in S67), the fans 511b and 512b of the air blowing portions 511A and 512A are stopped to stop the air blowing operation (S68), whereby the sheet feeding operation in the medium sensor mode is terminated. In addition, in a case where the separating process is already not being executed (N in S67), the sheet feeding operation in the medium sensor mode is ended immediately.

### Summary of First Embodiment

As described above, according to the image forming apparatus 201 of the first embodiment, it is possible to execute the medium sensor mode in which the type of the sheet S is detected by the medium detection sensor 280 while feeding the sheet S. Further, the separating setting (see FIG. 7) is executed to set the air blowing operation to be executed when the feeding of the sheet S is started by the execution of the medium sensor mode. As a result, for example, it is possible to prevent the air separation from being executed on the sheet S that does not require the air separation operation and the feeding of the first sheet S in the medium sensor mode from being delayed, whereby a decrease in the FCOT can be prevented.

When power is turned on (the apparatus wakes up from the power saving mode) (see FIG. 6), the separating setting (see FIG. 7) is executed to set the air blowing operation to be executed when the feeding of the sheet S is started by the execution of the medium sensor mode. As a result, when the job is started with the medium sensor mode having been chosen by the user, it is not necessary to perform the separating setting, and it is possible to prevent the feeding of the first sheet S from being delayed in the medium sensor mode.

Further, it is now assumed that the medium sensor mode has been chosen, and the undriven state (the button 902 for not performing air blowing in FIG. 8) of the air blowing operation (air separation operation) has been chosen in the separating setting. The job is started in this state, and the feeding of the sheet S is started by the execution of the medium sensor mode. When it is detected that the sheet S is of a type that requires air separation (Y in S71), the air blowing operation is switched to the driven state, which means that the separating process is executed (S72). As a result, even if the user erroneously sets the separating setting so as not to perform the air blowing operation, the air separation operation can be started in a subsequent sheet feeding, which prevents feeding failure from occurring.

### Second Embodiment

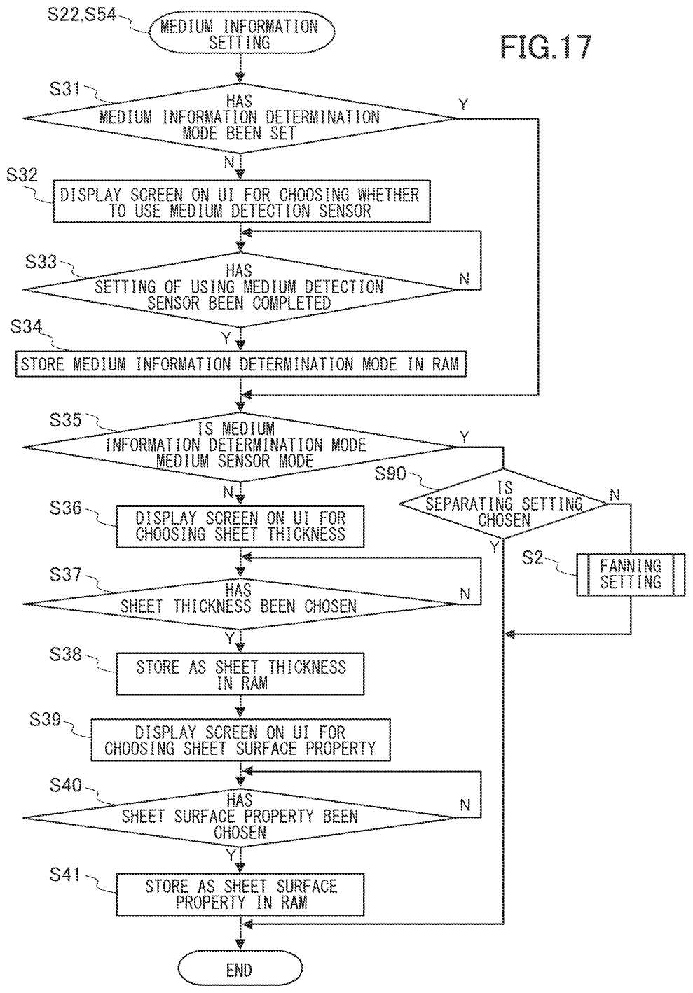

Next, a second embodiment that is partially modified from the first embodiment will be described with reference to FIG. 17. FIG. 17 is a flowchart illustrating a medium information setting process according to the second embodiment. In the description of the second embodiment, the same reference sings are used for the same parts as those of the first embodiment, and the description thereof will be omitted.

In the first embodiment described above, the separating setting process is executed to set the air blowing operation for the first sheet feeding in the medium sensor mode when the power is turned on (see FIGS. 6 and 7). In the second embodiment, the process performed when the power is turned on illustrated in FIG. 6 is not performed when the power is turned on. In the second embodiment, the separating setting process is performed when the medium sensor mode is selected in the medium information setting process executed when the sheet S is set in the sheet feed tray 236 or when a job is input.

Specifically, as illustrated in FIG. 9, the medium information setting process S22 illustrated in FIG. 17 is executed when the sheet S is set in the sheet feed tray 236 by the user (Y in S21). As illustrated in FIG. 17, similarly to the first embodiment, when the medium information determination mode is not stored (N in S31), the user is prompted to choose between the medium sensor mode and the user setting mode (S32 and S33). When the setting is completed (Y in S33), the choice is stored as the medium information determination mode (S34).

Although it is assumed in the present embodiment that, for example, the RAM 102 is reset and the medium information determination mode is not stored when the power is turned off or in a similar case, the present technology is not limited thereto. For example, in a case where the medium information determination mode chosen by the user is stored in another non-volatile memory or the like without being reset, it is determined that the medium information determination mode has already been set (Y in S31).

If the medium sensor mode is chosen as the medium information determination mode (Y in S35), it is determined whether the separating setting has been chosen (S90). When the separating setting has not been chosen (N in S90), the separating setting process described above (see FIG. 7) is executed. That is, the driven state (the button 901 for performing air blowing is pushed) or undriven state (the button 902 for not performing air blowing is pushed) is chosen for the air blowing operation during feeding of the first sheet in the medium sensor mode (see FIG. 8). In this way, once the air separation operation for the first sheet feeding in the medium sensor mode is set, the medium information setting process is ended. Since the case where the user setting mode is chosen as the medium information determination mode (N in S35) is similar to that in the first embodiment, the description thereof is omitted.

Although it is assumed in the present embodiment that, for example, the RAM 102 is reset and the driven or undriven state of the air blowing operation in the separating setting is not stored when the power is turned off or in a similar case, the present technology is not limited thereto. For example, in a case where the contents of the separating setting chosen by the user are stored in another non-volatile memory or the like without being reset, it is determined in step S90 that the separating setting has been chosen (Y in S90), and the medium information setting process ends.

As illustrated in FIG. 14, the above-described medium information setting process S22 illustrated in FIG. 17 is also executed in a case where a job is input and no medium information is set (N in S53). For example, in a case where a job is input before a sheet is set in the sheet feeding tray 236, the process illustrated in FIG. 14 is started without the process illustrated in FIG. 9 being executed. As a result, there may be cases where the medium information is not set. Even in such a case, when a job is input and the medium sensor mode is chosen as the medium information determination mode, the separating setting process can be executed, and the air blowing operation for the first sheet feeding in the medium sensor mode can be set.

As described above, in the second embodiment, the separating setting (see FIG. 7) for setting the air blowing operation to be executed when the feeding of the sheet S is started by the execution of the medium sensor mode can be executed in a case where the sheet is set in the sheet feeding tray 236. Alternatively, the separating setting can be executed when a job is input, that is, when the start of feeding by the manual feed portion 235 is instructed. Since these setting processes are continued when the medium sensor mode is chosen as the medium information determination mode, it is possible to avoid a situation in which the separating setting process is not executed even though the medium sensor mode is chosen.

The configuration, operations, and effects of the second embodiment other than this are similar to those of the first embodiment, and thus the description thereof will be omitted.

### Other Embodiments

In the first and second embodiments described above, the image forming apparatus 201 including the medium detection sensor 280, the controller 100, the manual feed portion 235, and the like has been described. However, the present technology is not limited thereto, and for example, a sheet feeding apparatus such as the feeding deck 800 may include the medium detection sensor, controller, and the like. The image forming apparatus is not limited to the image forming apparatus 201 of the present embodiment, and may refer to an image forming system including a feeding deck.

In the first and second embodiments, both the medium sensor mode and the user setting mode can be selectively executed as the medium information determination mode. However, the present technology is not limited thereto, and only the media sensor mode may be executed.

In the first and second embodiments, the sheet type is input by operating the operation portion 730 in the user setting mode. However, the sheet type information may be input by an external computer or the like via an interface in the user setting mode. In this case, the interface is the type input portion.

In the first and second embodiments, the process of choosing the medium information determination mode is executed by carrying out the medium information setting process when sheets are set in the sheet feeding tray 236 (see FIGS. 9, 10, and 14). However, the present technology is not limited thereto, and for example, the process of choosing the medium information determination mode may be executed before setting the sheets, such as when the power is turned on. In this case, the separating setting process may be executed in advance before the process of choosing the medium information determination mode, or executed immediately after the process of choosing the medium information determination mode or after the sheets are set.

The present disclosure can also be implemented by a process in which a program that implements one or more functions of the above embodiments is supplied to a system or an apparatus via a network or a storage medium, and one or more processors in a computer of the system or apparatus read and execute the program. The present disclosure can also be implemented by a circuit (for example, ASIC) that implements one or more functions.

According to the present invention, it is possible to prevent the feeding of the first sheet from being delayed in the first mode in which the type of the sheet is detected by the type detection portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-029977, filed Feb. 28, 2023 which is hereby incorporated by reference herein in its entirety.

What is claimed is:

1. A sheet feeding apparatus comprising:
a supporting portion configured to support a plurality of sheets;
a feeding portion configured to feed a sheet supported by the supporting portion;
a separating portion configured to blow air to the plurality of sheets supported by the supporting portion to separate the sheets;
a type detection portion configured to detect a type of the sheet fed by the feeding portion;
a control portion configured to control an air blowing operation by the separating portion according to the type of the sheet; and
a type input portion configured to be input information on the type of the sheet supported by the supporting portion,
wherein the control portion is configured to selectively execute
a first mode in which the type of the sheet supported by the supporting portion is set by information detected by the type detection portion while the sheet is fed, and
a second mode in which the type of the sheet supported by the supporting portion is set by the information input by the type input portion to execute feeding of the sheet, and
wherein the control portion is configured to execute
a setting process of setting the air blowing operation to be executed in the first mode, and
a choosing process of choosing one of the first mode and the second mode.

2. The sheet feeding apparatus according to claim 1, wherein the control portion is configured to execute the setting process before executing the choosing process.

3. The sheet feeding apparatus according to claim 2, wherein the control portion is configured to execute the setting process in a case where a power is turned on.

4. The sheet feeding apparatus according to claim 1, wherein the control portion is configured to execute the setting process in a case where the first mode is chosen by the choosing process.

5. The sheet feeding apparatus according to claim 1, further comprising:
a sheet detection portion configured to detect that the sheet is supported by the supporting portion,
wherein the control portion is configured to execute the setting process in a case where the first mode is chosen and the sheet detection portion detects that the sheet is supported by the supporting portion.

6. The sheet feeding apparatus according to claim 1, further comprising:
an operation portion configured to display a screen to execute the choosing process.

7. The sheet feeding apparatus according to claim 1, wherein the control portion is configured to execute the setting process in a case where the first mode is chosen and an instruction to start feeding by the feeding portion is given.

8. The sheet feeding apparatus according to claim 1,
wherein the control portion is configured to choose whether the air blowing operation is in a driven state or an undriven state in the setting process, and
wherein in a case where feeding of a plurality of sheets is started by executing the first mode, the air blowing operation is set in the undriven state, and the type of the sheet detected by the type detection portion is a type that requires the air blowing operation to be driven, the control portion is configured to switch the air blowing operation from the undriven state to the driven state.

9. An image forming apparatus comprising:
the sheet feeding apparatus according to claim 1; and
an image forming portion configured to form an image on a sheet fed by the sheet feeding apparatus.

10. The image forming apparatus according to claim 9, wherein the sheet feeding apparatus is a manual feed portion configured to manually feed a sheet to the supporting portion.

11. The image forming apparatus according to claim 10,
wherein the manual feed portion includes a side end regulating plate configured to regulate a position of the sheet supported by the supporting portion in a width direction orthogonal to a feeding direction, and
wherein the separating portion includes a fan and a duct configured to guide air blown from the fan to flow through an inside of the side end regulating plate and blow the air to a side of the sheet supported by the supporting portion in the width direction.
